(19) United States
(12) Patent Application Publication
(10) Pub. No.: US 2014/0093769 A1
(43) Pub. Date: Apr. 3, 2014

(54) Carbon Nanotube-Based Electrode and Rechargeable Battery

(71) Applicants: Ahmed Busnaina, Needham, MA (US); Sivasubramanian Somu, Natick, MA (US); Ankita Shah, Boston, MA (US)

(72) Inventors: Ahmed Busnaina, Needham, MA (US); Sivasubramanian Somu, Natick, MA (US); Ankita Shah, Boston, MA (US)

(73) Assignee: NORTHEASTERN UNIVERSITY, Boston, MA (US)

(21) Appl. No.: 14/118,814

(22) PCT Filed: May 21, 2012
(86) PCT No.: PCT/US2012/038847

§ 371 Date: Nov. 19, 2013

Related U.S. Application Data
(60) Provisional application No. 61/487,920, filed on May 19, 2011.

(51) Int. Cl. H01M 4/36; H01M 10/04; H01M 4/04

(52) U.S. Cl. CPC H01M 4/366; H01M 4/0402; H01M 10/049; Y10S 977/948; Y10S 977/742; B82Y 99/00
USPC 429/156; 429/231.8; 429/231.3; 429/224; 429/221; 429/231.5; 429/223; 427/122; 204/484; 204/486; 29/623.1; 977/948; 977/742

(57) ABSTRACT

Carbon nanotube-based electrode materials for rechargeable batteries have a vastly increased power density and charging rate compared to conventional lithium ion batteries. The electrodes are based on a carbon nanotube scaffold that is coated with a thin layer of electrochemically active material in the form of nanoparticles. Alternating layers of carbon nanotubes and electrochemically active nanoparticles further increases the power density of the batteries. Rechargeable batteries made with the electrodes have a 100 to 10000 times increased power density compared to conventional lithium-ion rechargeable batteries and a charging rate increased by up to 100 times.

### CROSS REFERENCE TO RELATED APPLICATIONS

This application claims the priority of U.S. Provisional Application No. 61/487,920 filed May 19, 2011 entitled NEXT GENERATION CARBON NANOTUBE BASED RECHARGEABLE BATTERIES, which is hereby incorporated by reference herein.

### STATEMENT REGARDING FEDERALLY SPONSORED RESEARCH

The invention was made with support from the U.S. Department of Defense. The United States Government has certain rights in the invention.

### BACKGROUND

The interfacial surface area between the electrodes plays a key role in the performance of a battery. Increasing the interfacial surface area generally has positive effects on current density, internal resistance, concentration polarization, and other characteristics that can affect discharge efficiency. While there have been many efforts to improve battery performance by increasing the interfacial surface area of the electrodes, there remains a need to develop new rechargeable batteries and components thereof, such as electrodes, that will increase the power density of the batteries and also will increase the rate of discharging and charging as well as the number of charging cycles without loss of storage capacity.

### SUMMARY OF THE INVENTION

The invention provides nanoelement-based electrode materials for rechargeable batteries. The electrodes are based on a carbon nanotube (CNT) scaffold that is coated with a thin layer of electrochemically active material in the form of nanoparticles. The use of alternating layers of CNT and active nanoparticles further increases the power density of the batteries. Rechargeable batteries made with the electrodes have a 100 to 10000 times increased power density compared to conventional lithium-ion rechargeable batteries and a charging rate increased by up to 100 times.

One aspect of the invention is an electrode for a rechargeable battery. The electrode includes an electrically conductive substrate and a first active material assembly layer deposited on the substrate. The active material assembly layer contains a layer of carbon nanotubes and a layer of electrochemically active nanoparticles. The active nanoparticles are deposited on a first side of the nanotube layer, and a second side of the nanotube layer is in electrical contact with the substrate. In some embodiments, the electrode contains two or more stacked active material assembly layers. In some embodiments, the electrode further contains an outer layer of carbon nanotubes.

Another aspect of the invention is an electrochemical cell containing an electrode according to the invention. Yet another aspect of the invention is a battery containing an electrode or an electrochemical cell according to the invention.

Still another aspect of the invention is a method of making an electrode for a rechargeable battery. The method includes the steps of: (a) depositing a layer of carbon nanotubes onto an electrically conductive substrate; and (b) depositing a layer of electrochemically active nanoparticles onto the layer of nanotubes. The layer of nanotubes together with the layer of nanoparticles forms a first active material assembly layer. In some embodiments a surface of the substrate is treated to remove surface contamination prior to depositing the carbon nanotubes. In some embodiments the method further includes step (c), depositing one or more additional active material assembly layers onto the first active material assembly layer.

### BRIEF DESCRIPTION OF THE DRAWINGS

FIG. 1 shows a plot of the theoretical surface area enhancement when using CNTs as the electrode material for a 2D configuration (CNT in laminar arrangement with respect to the current collecting substrate) as a function of the number of layers (m) and the active material loading conditions (x). The bottom curve depicts a loading factor of 25%, the next curve up depicts a loading factor of 50%, the second curve from the top depicts a loading factor of 75%, and the top curve depicts a loading factor of 100%.

FIG. 2 shows a plot of the theoretical surface area enlargement when using CNTs as the electrode material, in a 3D configuration (CNTs in vertical arrangement with respect to current collecting substrate) as a function of the length of the vertically aligned CNT (l) and the active material loading conditions (x). The bottom curve depicts a loading factor of 25%, the next curve up depicts a loading factor of 50%, the second curve from the top depicts a loading factor of 75%, and the top curve depicts a loading factor of 100%.

FIG. 3 shows the expected increase in power density as a function of active nanoparticle loading on the carbon nanotubes. The power density is shown for single-walled carbon nanotubes (SWNT), multi-walled carbon nanotubes (MWNT), and compared to a reference value for nanotubes uniformly coated with a 10 nm thick active cathode material solid layer.

FIG. 4 shows an embodiment of a multi-layer electrode structure consisting of alternating layers of carbon nanotubes and lithium ion active material deposited on a current collecting substrate.

FIG. 5 shows SEM micrographs of CNT scaffolding on an aluminum substrate surface. The inset shows high magnification image.

FIG. 6 shows the results of cyclic voltammetry carried out on CNTs assembled on an aluminum substrate. The voltage window was 3-4.5V, and the scan rate was 1 mV/s.

FIG. 7 shows SEM images of a spin-casted active material layer onto MWNT layer.

FIG. 8 shows the discharge capacity as a function of the number of layers in the multi-layer structure (upper panel). Multilayer electrode schematics for 1-4 layers are shown in the lower panel.

FIG. 9 shows the normalized half-cell discharge capacity versus cycle number. Charge/discharge rates are denoted as C-rates in the caption. Time to discharge equals 1/C hours.

FIG. 10 presents a schematic diagram illustrating a process of active material deposition via electrophoretic assembly for the formation of a battery electrode.

FIG. 11 shows the zeta potential distribution of LiMn₂O₄ particles suspended in ethanol solutions. In FIG. 11A the solution contained only ethanol. Average zeta potential was 0 mV, with a standard deviation of 16.7 mV. In FIG. 11B the ethanol solution contained 0.05 mg/ml gallic acid. The average zeta potential was −55 mV, with a standard deviation of 15 mV.

FIG. 12 shows the particle size distribution of LiMn₂O₄ particles suspended in ethanol solutions. FIG. 12A shows the results for a solution containing only ethanol. The average particle size was 804.7 nm. FIG. 12B shows the results for a solution containing 0.05 mg/ml gallic acid in ethanol. The average particle size was 238 nm.

FIG. 13 shows SEM images of LiMn₂O₄ assembled on a MWNT layer. Average particle size is 250 nm.

FIG. 14 shows the results of cyclic voltammetry carried out on LiMn₂O₄ particles assembled on CNT scaffolding deposited on an aluminum substrate. Scan rate was 20 μV/s.

FIG. 15 shows the results of galvanostatic cycling at of multilayer electrodes at various charge and discharge rates (C-rate). The electrode structures are shown in schematic in the upper right portion of the Figure. “Red curve” refers to the lower curve, while “blue curve” refers to the upper curve.

FIG. 16, top portion, shows a schematic illustration of the cross section of an electrode containing a surface layer of MWNT in addition to an active material assembly layer. The bottom portion of FIG. 16 shows an SEM image of the outer surface layer of MWNT of the electrode.

FIG. 17 shows a high voltage current-voltage curve from a half cell of a half cell in which LiMn₂O₄/MWNT/Al serves as the cathode, Li foil as the anode and LiPF₆/EC/DMC as the electrolyte.

### DETAILED DESCRIPTION OF THE INVENTION

The inventors have developed new nanoelement-based electrode materials that can be used to assemble rechargeable batteries having a 100 to 10000 times increased power density compared to conventional lithium-based rechargeable batteries and a charging rate increased by up to 100 times. The electrodes utilize alternating layers of active material assemblies, each assembly layer containing a layer of carbon nanotubes (CNT) and a layer of nanoparticulate active electrode materials. A current collecting substrate contacts the CNT layer of the first active material assembly, and the battery electrolyte contacts the uppermost active material layer. This basic electrode structure can be employed both at the cathode and the anode. The design of the electrodes results in vastly increased power density per unit of surface area.

Two different designs can be considered for increasing the interfacial surface of the electrodes. The first is a two-dimensional configuration, having two or more active material assembly layers forming a lamellar stack that is deposited onto the current collector. The second is a three-dimensional configuration, which has vertically aligned CNTs perpendicular to the plane of the current collector, with active material coating the CNTs. Both designs can provide increased interfacial surface area between the electrodes and lower battery internal resistance. One source of the improvement is that fact that the resistivity of traditionally used carbon black material is 10⁻² to 10¹ Ωcm, while that of aligned CNTs is approximately 10⁻³ to 10⁻⁴ Ωcm.

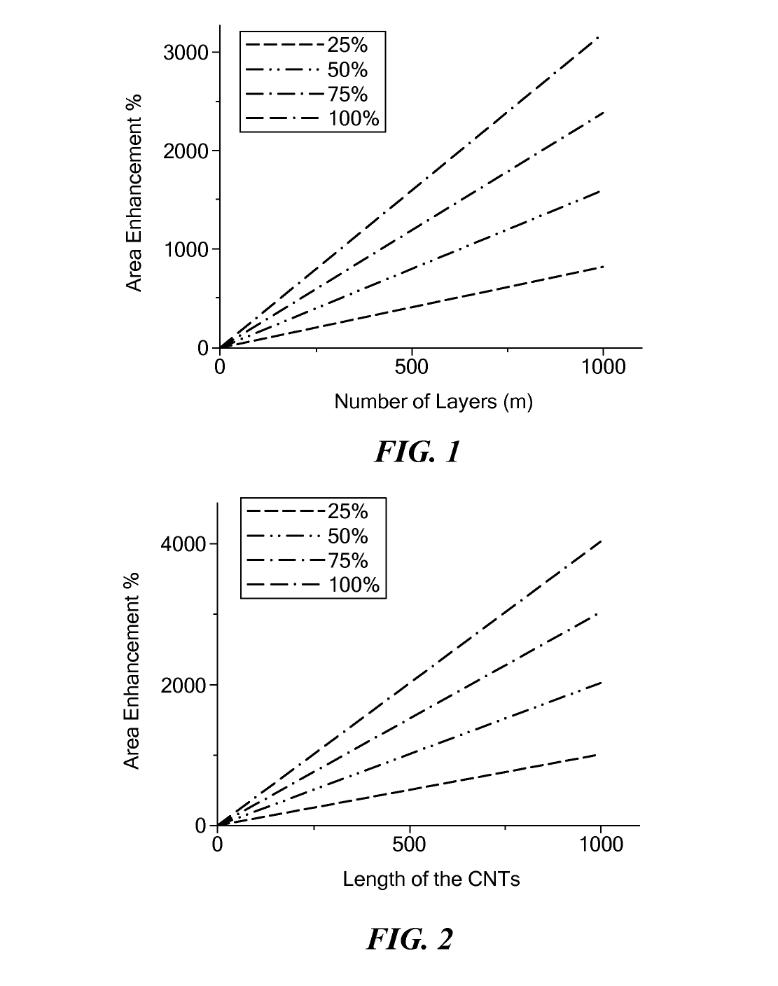

The surface enhancement for the 2D configuration is given by the relation

$$Area enhancement = ( \frac{{Area}_{fin} - {Area}_{in}}{{Area}_{in}} ) = [ ( m - \frac{1}{2} ) π - 1 ] x ,$$

where “m” is the number of layers of active material assemblies and “x” is the loading factor, i.e., the fraction of the CNT surface covered with active material. FIG. 1 depicts the expected effect of the number of active material assembly layers and the loading factor on the area enhancement compared to a solid active material layer having a flat surface.

For the 3D configuration, the area enhancement is given by

$$Area enhancement = ( \frac{{Area}_{fin} - {Area}_{in}}{{Area}_{in}} ) = \frac{4 x 1}{D} ,$$

where “l” is the length of the CNTs, “D” is the diameter of the CNTs, and “x” is the loading factor. FIG. 2 depicts the expected effect of the CNT length and the loading factor on the area enhancement compared to a solid active material layer having a flat surface.

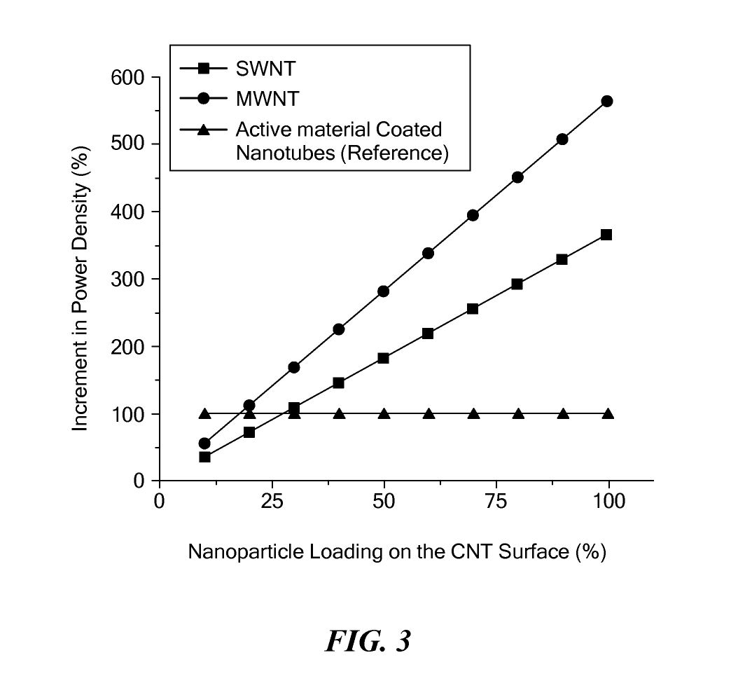

An ideal configuration for a CNT based Li-ion battery would have the CNTs coated with a thin layer of active material. Such a battery would have extremely high power density compared to existing batteries. The present invention provides an alternative to chemical methods for producing such a battery, in that the ideal structure is approximated using CNTs coated with nanoparticulate active electrode material. The expected power density dependence on loading of SWNT and MWNP with active material nanoparticles is shown in FIG. 3. As can be seen from the figure, a nanoparticle loading of about 50% is expected to increase the power density 280% and 180% for MWNT and SWNT, respectively. The reference power density (100%) is taken as a battery in which the cathode contains CNT coated with a uniform layer of cathode material of thickness 10 nm. The diameters of SWNT are assumed to be 1 nm and MNNT to be 100 nm.

Thus, according to the invention, a battery employing multiple alternating layers of CNT and active nanoparticulate cathode material has a power density at least two orders of magnitude greater than that of a conventional battery, due to the combined effect of area enhancement obtained by using CNT and increased power density obtained by loading the CNT with nanoparticulate active material. Further enhancement is obtained by using analogous structures for both the cathode and the anode of a battery, with appropriate active materials selected for each electrode and for compatibility with the electrolyte material.

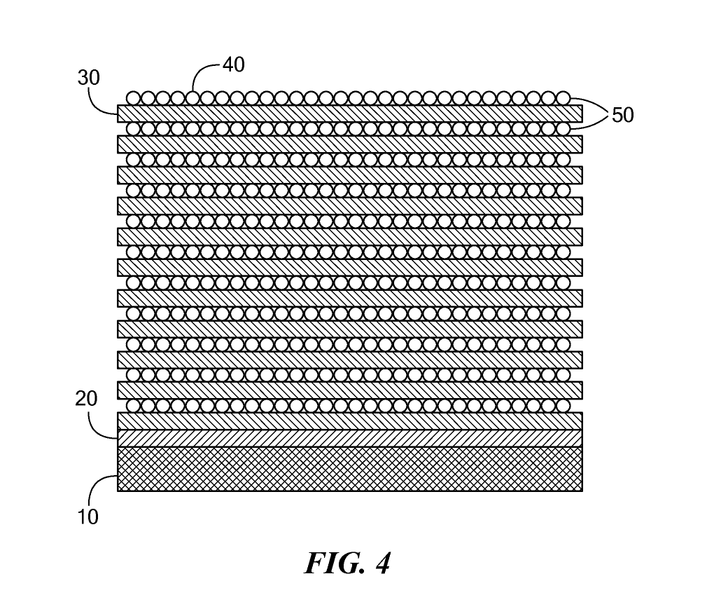

FIG. 4 shows a schematic of a multilayer electrode structure according to the invention. This general structure can be used for either the cathode or anode of a battery, or both. At the base of the structure is a current collecting substrate material (10). The material is preferably a conductive metal such as aluminum, copper, or another metal or metal alloy. The thickness and geometry of the current collecting substrate can be any desired thickness and shape, according to the particular battery design. A surface (20) of the current collector is treated by mechanical abrasion (e.g., with fine sandpaper or other abrasive material) or chemical cleaning or etching (e.g., washing with an organic solvent, which is then removed by drying or evaporation) so as to remove any surface contamination, such as organic surface material. A layer of CNT (30) is deposited onto the treated surface, where it serves as a scaffold for the attachment of active material. A layer of nanoparticulate active material (40) is deposited onto the CNT layer. The combination of a CNT layer (30) and a layer of active material (40) deposited thereon forms a unit referred to herein as an “active material assembly layer” (50).

The active electrode materials can be selected based upon known combinations of cathode and anode materials and their compatibility with the chosen electrolyte. For example, suitable cathode active materials for a Li ion battery include, but are not limited to, LiCoO₂, LiMn₂O₄, LiFePO₄, LiNiO₂, LiNiMnCoO₂, Li₂FePO₄F, LiCo_{0.33}Ni_{0.33}Mn_{0.33}O₂, Li(LiₐNiₓMn_{y}Co_{z})O₂ (also known as NMCs), LiNiCoAlO₂, Li₄Ti₅O₁₂, Li₃V₂(PO₄)₃. Suitable anode active materials include, but are not limited to, graphene; silicon, V₂O₅, TiO₂, and metal hydrides. Active materials for both anodes and cathodes are deposited onto a CNT scaffold. The active material is applied in the form of a suspension of nanoparticles having an average particle size (e.g., diameter) in the range from about 10 nm to about 1000 nm. Some such materials are commercially available in an appropriate size range. Others may be available only as larger particles which can be reduced in size by conventional techniques, including ball milling or ultrasonication to reduce the size, and centrifugation to remove larger particles.

Examples of liquid electrolyte components for Li ion batteries include, but are not limited to, LiPF₆, LiBF₄. LiClO₄, ethylene carbonate (EC), dimethyl carbonate (DMC), and diethyl carbonate. Solid polymer electrolytes are also known, such as those used in Li ion batteries, and can be used in a battery according to the invention. While Li ions are preferred as the charge carrier, a battery according to the invention can utilize any suitable ionic species as the charge carrier. Other charge carriers, such as Ni, Na, and K ions, are known in the art, as well as suitable electrolytes, e.g., liquid or solid electrolytes, and electrochemically active electrode materials for use therewith. Batteries according to the invention can have any form, such as commonly used forms including cylindrical cells, coin cells, pouch cells, prismatic cells, film batteries, and the like.

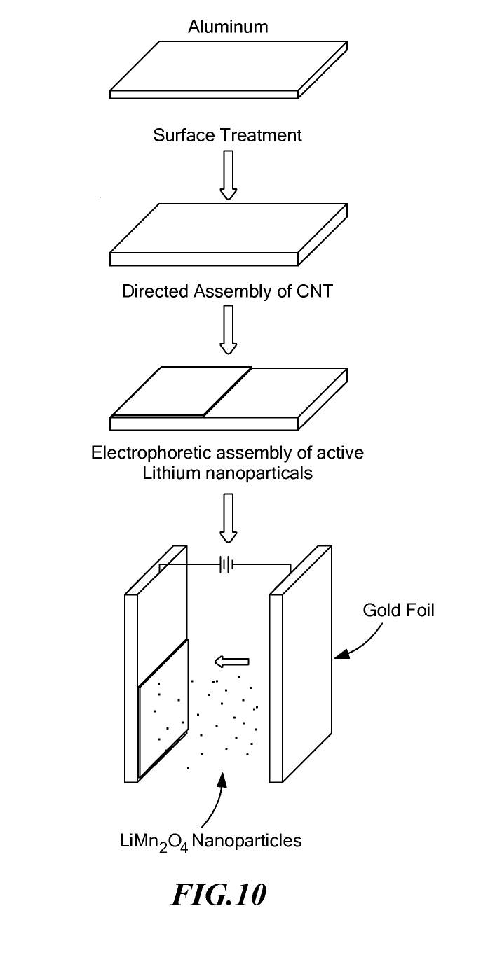

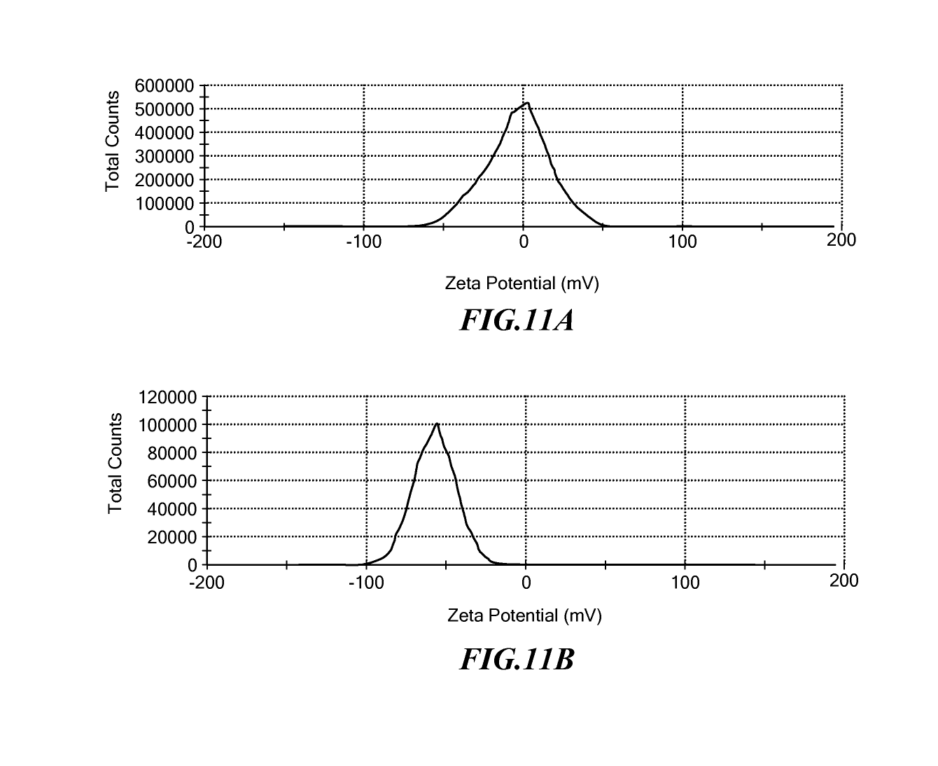

A diagram of an embodiment of a method of producing a battery electrode according to the invention is shown in FIG. 10. The surface of the current collector is treated by mechanically roughening it with an abrasive material, such as fine sand paper, to remove surface contamination. Alternatively, an organic solvent can be used to treat the surface, removing organic contamination. CNTs are then deposited onto the current collector. Commercially available CNT can be used, including either SWNT and MWNT. The nanotubes can be selected for their desired electrical properties, e.g., either metallic or semiconducting. The method of CNT deposition can be carried out using various methods including spin-casting, electrophoretic assembly, fluidic assembly, and directed assembly. See, e.g., Published Patent Applications US2009/0134033, US2010/0183844, WO2009/075720, and WO2008/054411. The layer of CNT can be as thin as a single nanotube in thickness, but is preferably between about 10 nm and 1000 nm in thickness. Active material nanoparticles, e.g., lithium ion-containing nano-sized active particles are deposited on top of the carbon nanotube layer. Again, deposition of the active nanoparticles can be carried out using methods including spin-casting, electrophoretic assembly, fluidic assembly, and directed assembly. Preferably, at least 50% of the exposed CNT surface area is covered with active material nanoparticles. In certain embodiments, at least 70%, at least 90%, at least 95%, at least 98% or at least 99% is covered. The deposition of carbon nanotubes and lithium ion active material is repeated as necessary to obtain the multilayered structure and the desired electrode capacity. Preferably, an electrode has a stack containing at least 2 active material assembly layers. In certain embodiments, the electrode has at least 7 or at least 8 active material assembly layers, and can have up to 500 or even more.

Nanotubes or nanoparticles for deposition as components of an electrode are prepared as stable liquid suspensions. The suspension can be prepared in water or an organic solvent, such as an alcohol. In order to promote stability of the suspension, i.e., to prevent aggregation, a low concentration of a chelating agent (e.g., gallic acid) or one or more surfactants, such as Triton X-100, ethylene glycol, or sodium dodecyl sulfate (SDS), can be added. Reducing the particle size distribution will further contribute to the stability of the LiMn2O4 suspension. Methods to reduce the particle size include mechanical ball milling, ultrasonication, and centrifugation.

As used herein, the rate of charging or discharging of a rechargeable battery is defined in units of “C”, where “C” is the rate of charging or discharging (i.e., current flow) that will substantially completely charge or discharge the battery in one hour. Batteries according to the invention have a charging rate of at least 5C, at least 10C, at least 20C, or at least 30C.

### EXAMPLES

### Example 1

### Electrode Produced by Spin-Casting

In this example, both the carbon nanotube layers and lithium ion active material layers were repeatedly spin-casted to construct multi-layer electrodes. Aluminum was used as the current collecting substrate for the cathode. The surface of the aluminum was roughened using fine sandpaper. A suspension of multi-walled carbon nanotubes (MWNT) suspended in n-methyl-2-pyrollidone (NMP) was spin-casted onto the roughened aluminum surface. The spin-casting procedure was repeated as necessary to obtain the desired thickness (1 micron thickness is obtained in this case, although a single monolayer of MWNTs could also be used. Typical MWNT loading was 100-200 μg per 1.0 cm² of roughened aluminum surface.

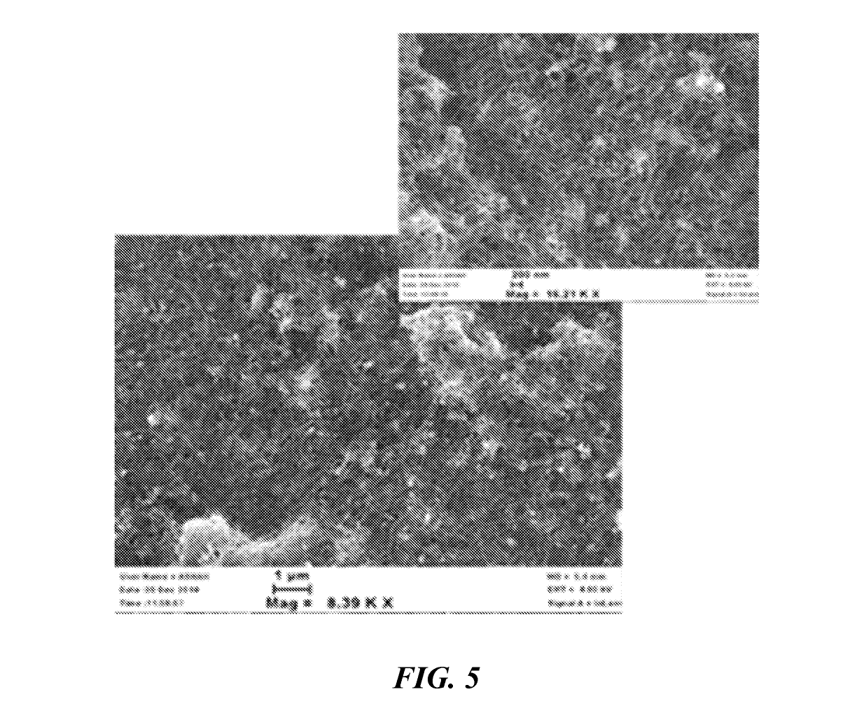

FIG. 5 shows scanning electron micrographs of multi-walled carbon nanotubes deposited onto the roughened aluminum substrate via spin-coating. Carbon nanotube deposition was highly uniform as the aluminum surface is fully covered. Carbon nanotubes were randomly oriented on the aluminum surface.

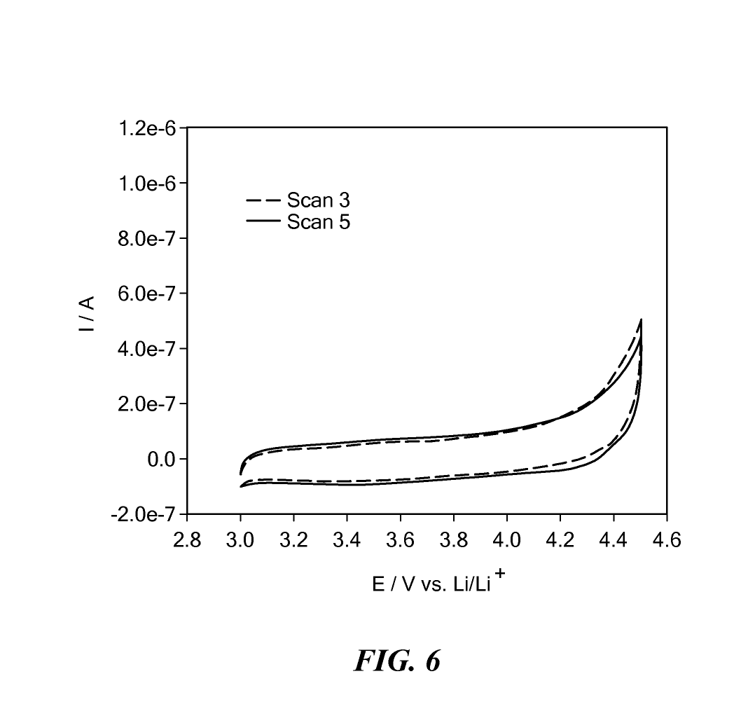

FIG. 6 demonstrates electrochemical testing of the carbon nanotube layer via cyclic voltammetry (CV) at a scan rate of 1 mV/s. The current profile of MWNT remained flat in the voltage window of lithium ion active material (3.5-4.5V), indicating that MWNT did not exhibit electrochemical interactions with lithium. The current spike at 4.2V is typical of the oxidation of organic electrolyte. The layer of lithium manganese oxide (LiMn₂O₄) active material was added onto the carbon nanotube layer. In this method, LiMn₂O₄ was mixed together in a slurry with carbon black (CB) and polyvinylidene fluoride binder (PVDF) in NMP solvent.

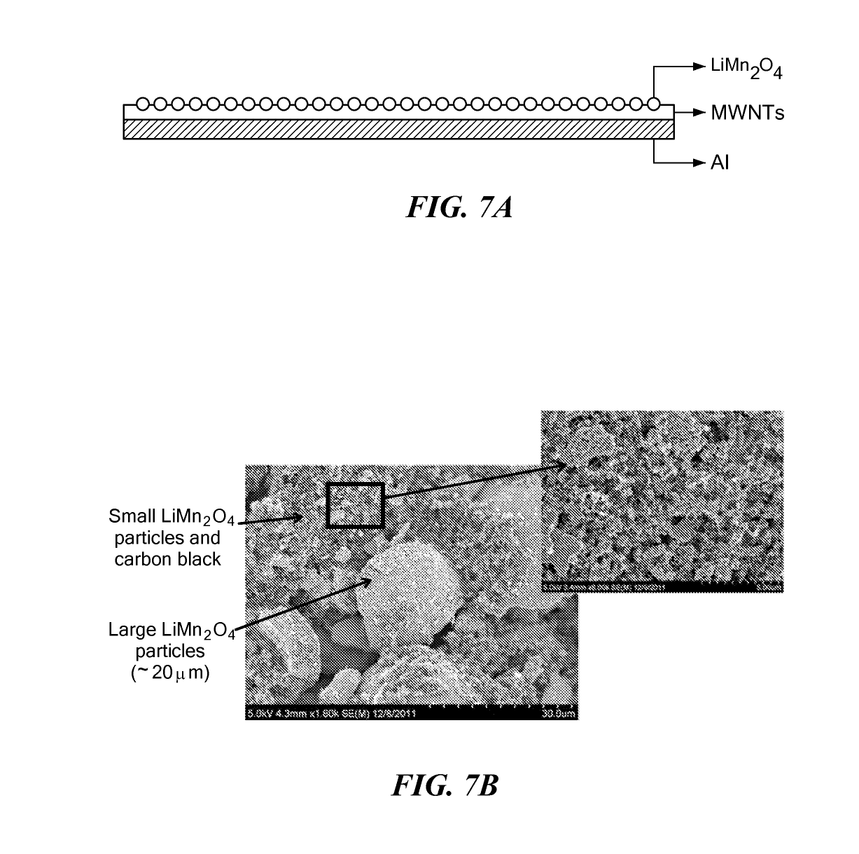

FIG. 7 shows SEM images of an active material layer consisting of LiMn₂O₄ particles, CB, and PVDF. LiMn₂O₄ particle sizes ranged from 100 nm-20 μm while the CB particle size showed a narrow distribution around an average of about 50 nm. The concentration of the slurry can be adjusted to control the loading of the active material layer. Table 1 shows that as the concentration of the slurry increases, the loading of the active material layer on the aluminum electrode surface increases.

TABLE 1
Composition of Active Material Slurries and
Corresponding Active Material Loading.

| | NMP Volume | PVDF | LiMn₂O₄/Carbon Black | Loading |
|---|---|---|---|---|
| Sample | (μL) | (mg) | (mg) | (mg/cm²) |
| 1 | 300 | 3 | 97 | 1.17 |
| 2 | 225 | 3 | 97 | 2.63 |
| 3 | 150 | 3 | 97 | 3.25 |

NMP: N-methyl pyrrolidine,
PVDF: polyvynilidine fluoride.

Multi-layer electrodes containing stacks of from one to four layers were constructed using the spin-casting method. The composition of the active material was 77% LiMn₂O₄, 20% CB and 3% PVDF. The active material loading was approximately 2 mg/cm² per active material layer, while the loading of the intermittent multiwalled carbon nanotube layers was 100-200 μg per layer.

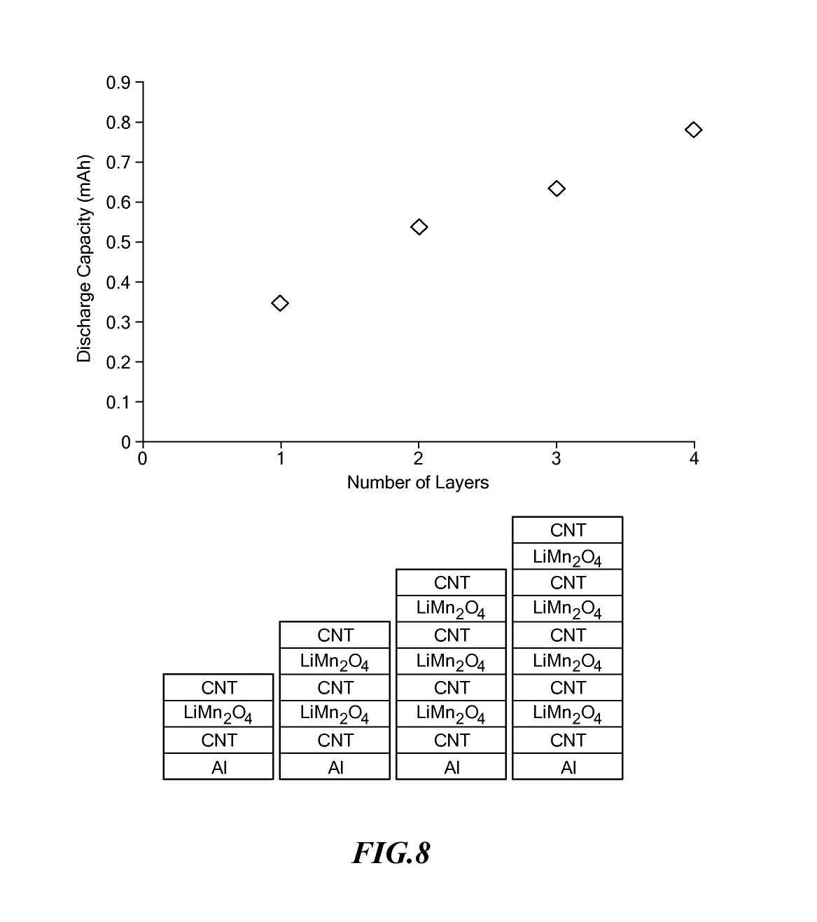

FIG. 8 shows the discharge capacity versus the number of layers of the multilayer electrodes. The discharge capacities were determined via galvanostatic cycling at a rate of C/10. FIG. 8 demonstrates a linear increase in discharge capacity with the number of multi-layers. This behavior suggests that the loading of the active material layer is consistent at each active material layer.

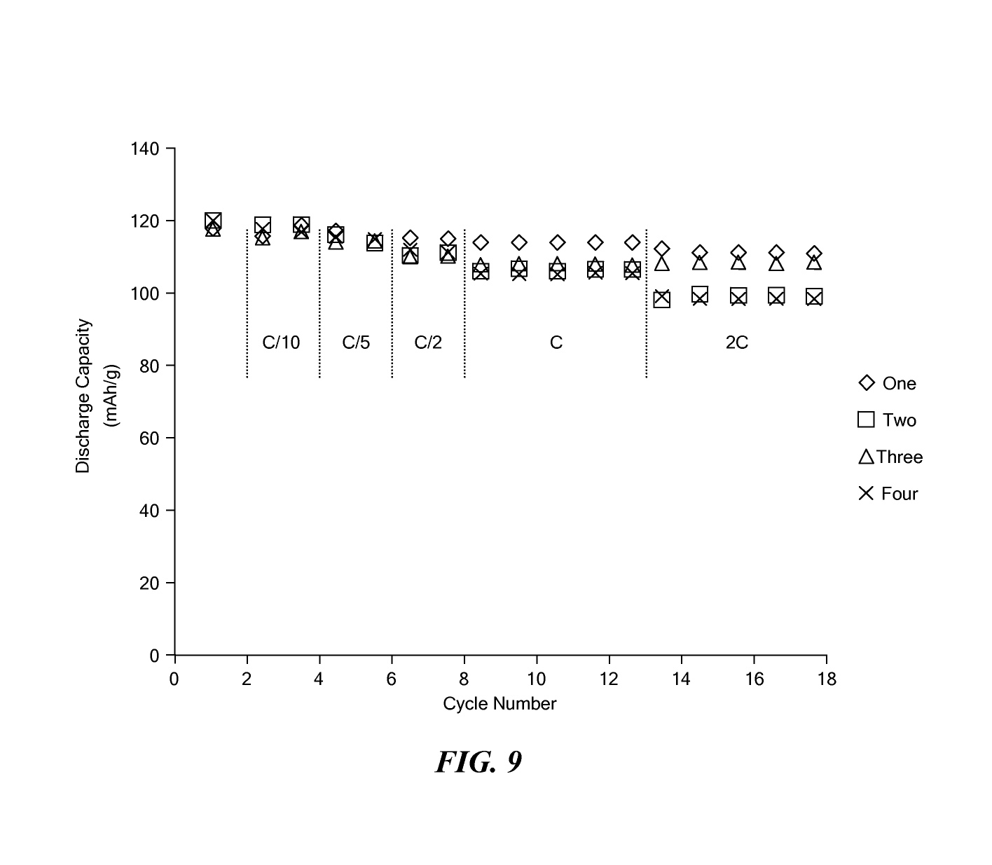

In FIG. 9, the normalized electrode discharge capacities obtained from galvanostatic cycling are plotted as a function of the cycle number. Both the charge and discharge rates were varied over the course of the cycling program from C/10 to 2C. At a rate of C/10, all four electrodes exhibit capacities within 2% of the theoretical capacity (118.4 mAh/g) of LiMn₂O₄. As the rate is increased, all of the electrodes exhibited some capacity fading; however, the capacity fading was not consistent for all four electrodes. As the C-rate continued to increase, the one layer electrode demonstrated the best capacity retention, exhibiting only a 5% capacity loss at a rate of 2C. The three-layer electrode exhibited a 7% capacity loss at a rate of 2C. The two and four layer electrodes exhibited a 17% capacity loss at a rate of 2C.

### Example 2

### Electrode Produced by Electrophoretic Assembly

In this example, electrophoretic assembly was employed to construct the active material layer. The surface of the aluminum current collector was roughened with sand paper. MWNT were spin-casted onto the aluminum surface. The aluminum electrode and a counter electrode were dipped into a stable suspension of LiMn₂O₄ particles in an organic solvent (ethanol or NMP). When an external electric field (about 50V or greater) was applied, the surface charge on the LiMn₂O₄ particles in suspension caused them to migrate to the aluminum electrode and assemble onto the MWNT layer (FIG. 10). Ethanol was used as the solvent; however other solvents such as isopropanol, acetone, n-methyl-2-pyrollidone, dimethyl formamide, hexane, toluene, and aqueous solvents of various pH also could be used. The suspension was stabilized by adding a small concentration (0.05 mg/ml) of gallic acid as a chelating agent.

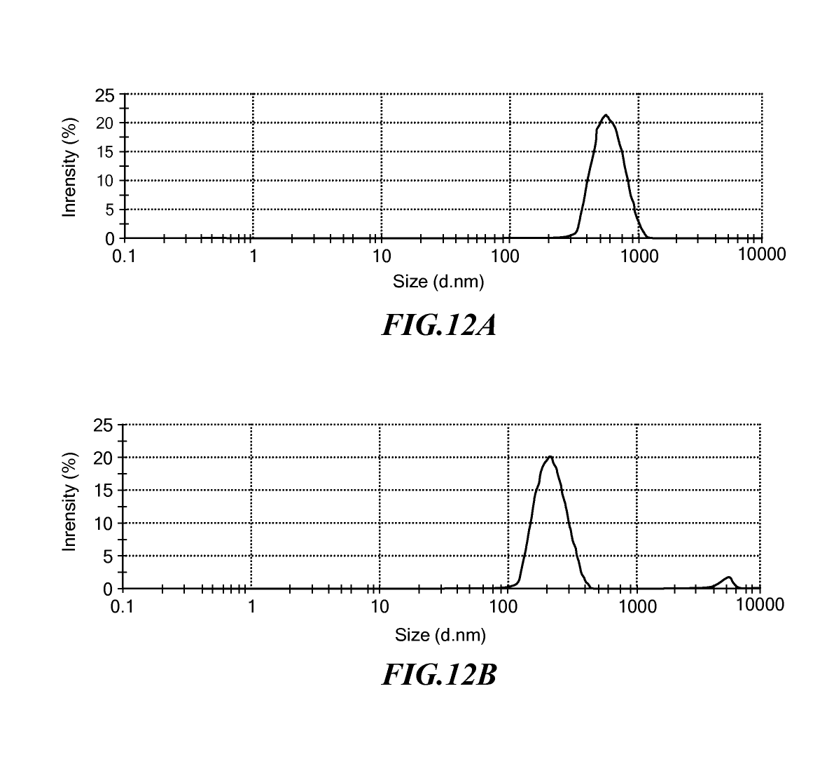

FIG. 11 shows the change in zeta potential of LiMn₂O₄ particle distribution with the use of 0.05 mg/ml gallic acid as a chelating agent. The absolute value of the zeta potential increased from 0 mV to 60 mV after the gallic acid was added. Similarly, FIG. 12 shows that the average particle size was reduced from 800 μm to 250 μm as particle agglomeration was reduced.

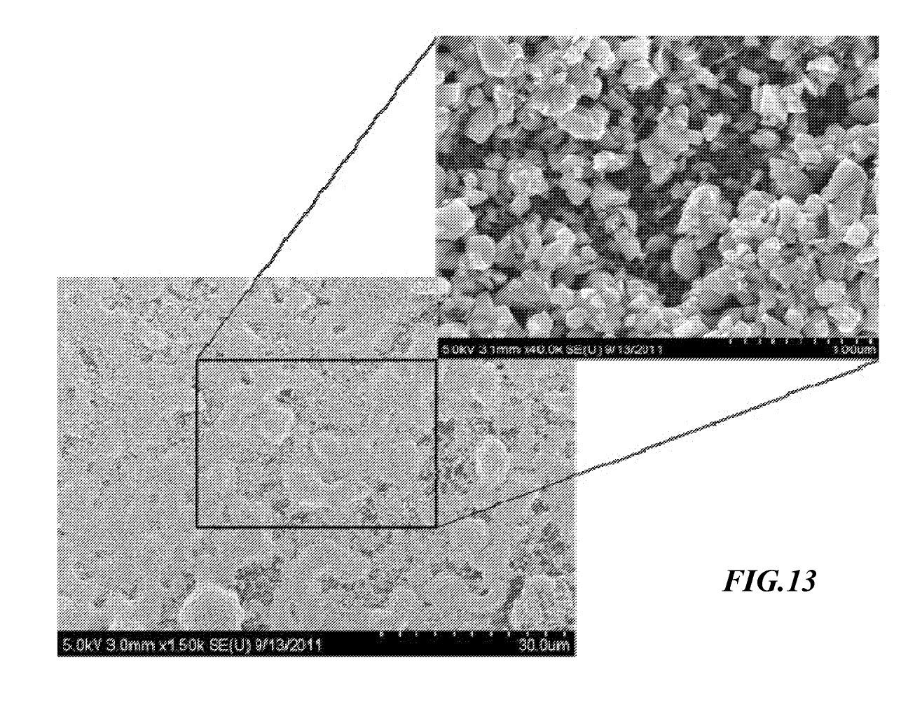

FIG. 13 shows scanning electron micrographs of LiMn₂O₄ particles assembled via electrophoretic assembly on a multi-wall carbon nanotube layer. Particle assembly was highly uniform, with greater than 90% of the MWNT surface utilized, i.e., coated with LiMn₂O₄ particles, based on SEM observations. The average particle size was 200-300 nm, with occasional larger particles present. By tuning electrophoretic assembly parameters such as applied voltage (typically >50 V), assembly time (typically >30 sec), and electrode distance (e.g., >1 mm), LiMn₂O₄ loading can be adjusted as necessary.

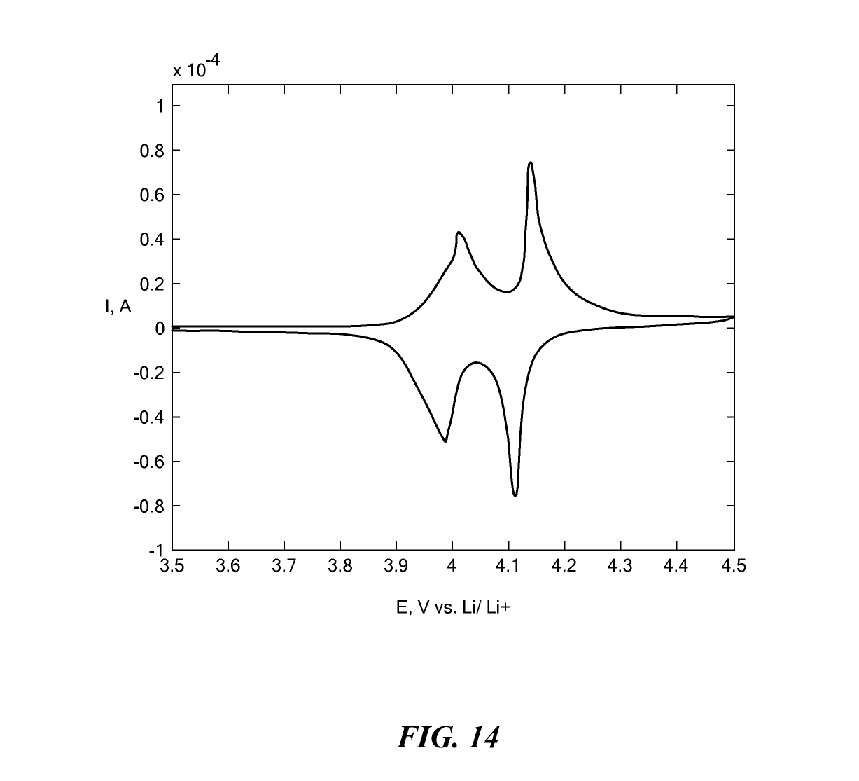

FIG. 14 shows cyclic voltammetry in the voltage window of 3.5-4.5V of LiMn₂O₄ assembled electrophoretically on a MWNT layer. The curve demonstrates current peaks at 3.9V and 4.2V, which is characteristic of lithium intercalation in LiMn₂O₄.

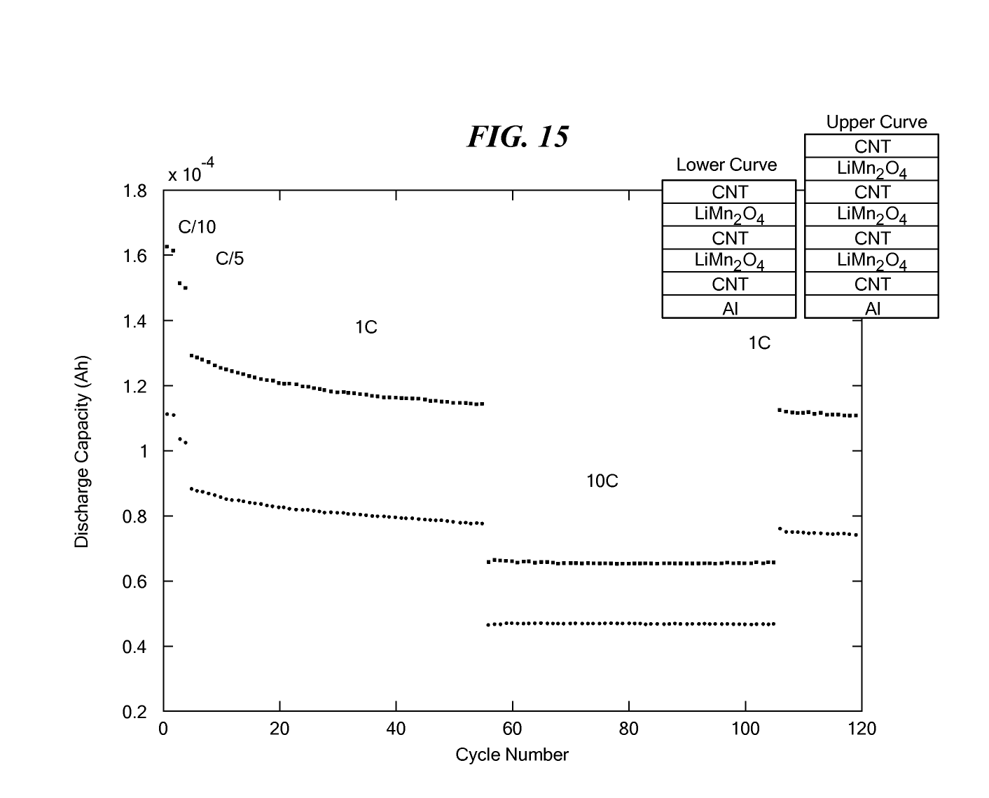

FIG. 15 shows the results of constant-current (galvanostatic) testing of multi-layer electrodes at various discharge rates. The discharge rate is given as a C-rate which indicates the time to discharge is 1/C hours. Multi-layer electrodes demonstrated a stable capacity over up to 100 cycles at high C-rates.

### Example 3

### Electrode with Outer Layer of Carbon Nanotubes

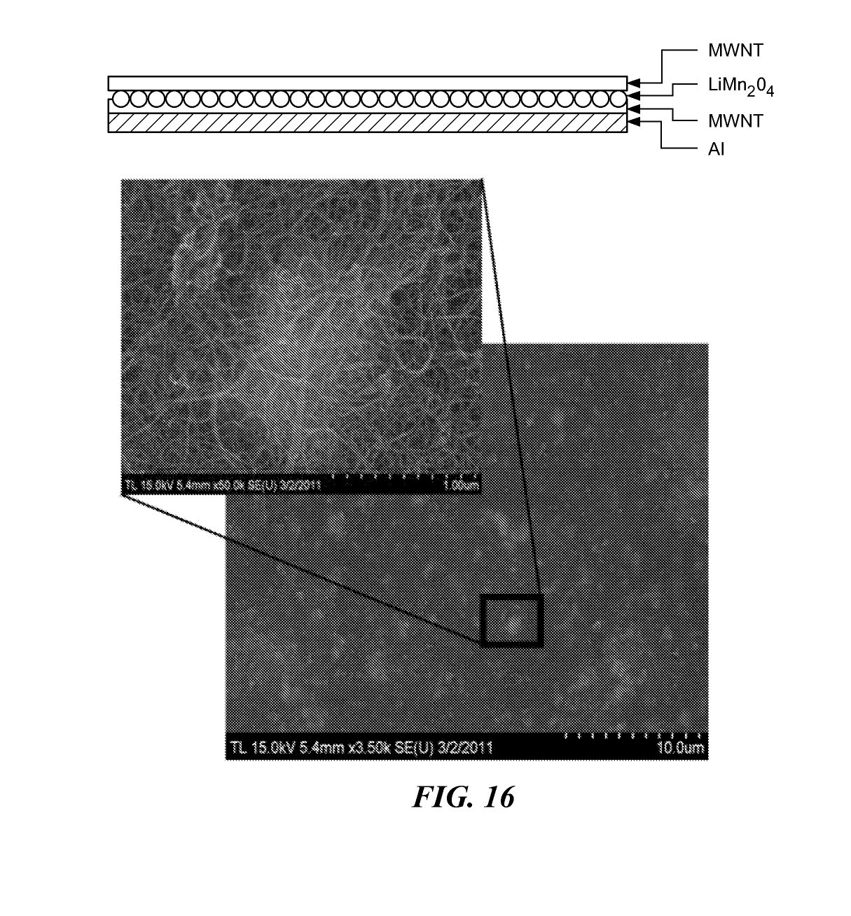

An electrode structure was prepared similar to that in Example 2, containing an aluminum substrate/current collector, a layer of MWNT on the treated aluminum surface, and a layer of LiMn₂O₄ particles deposited on the MWNT. Then, an additional layer of MWNT was deposited electrophoretically onto the LiMn₂O₄ layer. FIG. 16 shows an SEM image of the surface of the electrode. The upper part of the figure shows the cross section of the structure in schematic form. The lower part of the figure shows the outer surface layer of MWNT deposited onto the underlying LiMn₂O₄ particles.

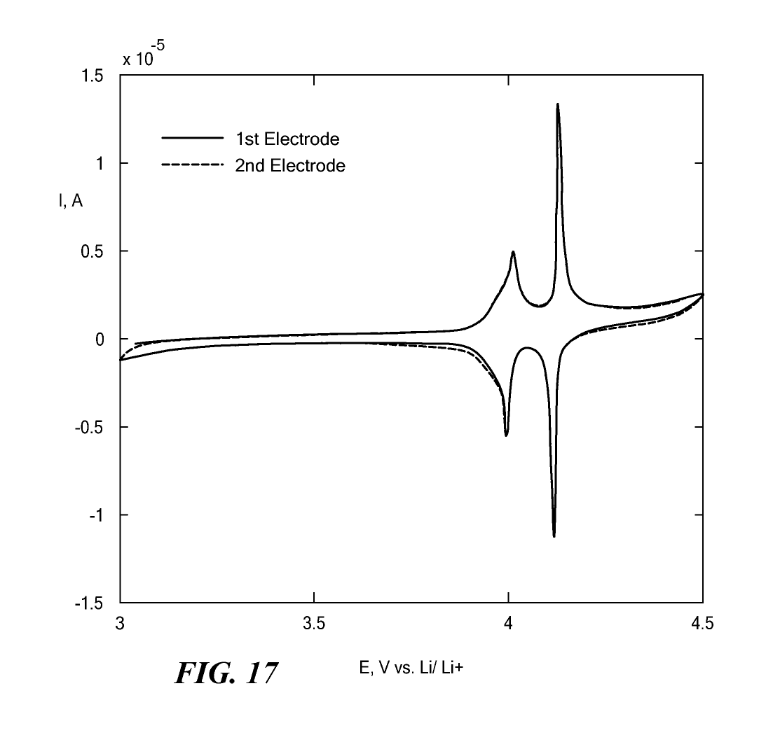

FIG. 17 shows the results of cyclic voltammetry using this electrode. The characteristic current peaks are maintained at 3.9V and 4.2 V. However, there was a 4-fold increase in current due to the addition of the final MWNT layer. This demonstrates that more power can be supplied by a multilayered electrode structure.

### REFERENCES

1. Directed Assembly of Carbon Nanotubes and nanoparticles Using Nanotemplates with Nanotrenches and Nanowires WO 2008/054411.
2. Xiong, Xugang, Jaberabsari, Laila, Hahm, Myung Gwan, Busnaina, Ahmed, and Jung, Yung, Joon Jung, “Building Highly Organized Single-Walled-Carbon-Nanotube Networks Using Template-Guided Fluidic Assembly,” Small-Journal, 2007, vol. 3, issue 12, Dec. 3, 2007, pp. 2006-2010.
3. Jaber-Ansari, Laila, Hahm, Myung Gwan, Somu, Sivasubramanian, Echegoyen Sanz, Yolanda, Busnaina, Ahmed and Jung, Yung Joon, “Mechanism of Very Large Scale Assembly of SWNTs in Template Guided Fluidic Assembly Process,” J. Am. Chem. Soc., 2009, 131 (2), pp 804-808.
4. Jaber-Ansari, Laila, Hahm, Myung Gwan,Kim, Tae Hoon, Somu, Sivasubramanian,Busnaina, Ahmed and Jung, Yung Joon, “Large Scale highly Organized Single-walled Carbon Nanotube Networks for Electrical Devices,” Applied Physics A (5194), Springer-Verlag 2009, Published Online: Apr. 3, 2009, pp. 373-377
5. Xiong, X., Chen, C.-L., Ryan, P., Busnaina, A. A., Jung, Y. J. and Dokmeci, M. R., “Directed Assembly of High-density Single-Walled Carbon Nanotube Patterns on Flexible Polymer Substrates,” Nanotechnology, 20, pp. 295302-308, July 2009.
6. Y. Kim, B. Li, X. An, M. Hahm, A. Busnaina, S. Kar, and Y. Jung, “Highly Aligned Scalable All-metallic Singlewalled Carbon Nanotubes Arrays for Electrical Nanoscale Interconnects”, ACS Nano, 3, 2818 (2009).
7. D. Golodnitsky et al Journal of Power Sources 153 (2006) 281.
8. Wang et al. Electrochemical and Solid-State Letters 7(11) 2004 A435.

That which is claimed is:

1. An electrode for a rechargeable battery, the electrode comprising:
an electrically conductive substrate; and
a first active material assembly layer deposited on the substrate, wherein the active material assembly layer comprises a layer of carbon nanotubes and a layer of electrochemically active nanoparticles deposited on a first side of the nanotube layer, and wherein a second side of the nanotube layer is in electrical contact with the substrate.

2. The electrode of claim 1, further comprising one or more additional active material assembly layers deposited on the first active material assembly layer.

3. The electrode of claim 2, wherein at least 2 active material assembly layers are arranged in parallel layers covering the surface of the substrate.

4. The electrode of claim 2, wherein at least 7 active material assembly layers are arranged in parallel layers covering the surface of the substrate.

5. The electrode of claim 2, wherein the carbon nanotube layer of each active material assembly layer forms an electrical contact with the carbon nanotube layers of adjacent active material assembly layers.

6. The electrode of claim 1, wherein the nanoparticles are disposed as a monolayer covering the layer of carbon nanotubes.

7. The electrode of claim 6, wherein at least about 50% of the exposed surface area of the nanotubes is covered by the nanoparticles.

8. The electrode of claim 1, wherein the nanoparticles have an average size from about 10 nm to about 1000 nm.

9. The electrode of claim 1, wherein the electrode is a cathode for a Li ion battery and the active nanoparticles comprise a material selected from the group consisting of LiCoO₂, LiMn₂O₄, LiFePO₄, Li₃V₂(PO₄)₃, LiNiO₂, LiNiMnCoO₂, Li₂FePO₄F, LiCo_{0.33}Ni_{0.33}Mn_{0.33}O₂, Li(LiₐNiₓMn_{y}Co_{z})O₂, LiNiCoAlO₂, Li4Ti₅O₁₂, and Li₃V₂(PO₄)₃.

10. The electrode of claim 1, wherein the electrode is an anode and the electrochemically active nanoparticles comprise a material selected from the group consisting of silicon, graphene; V₂O₅, TiO₂, and a metal hydride.

11. The electrode of claim 1, which is capable of use in a rechargeable battery with a liquid electrolyte comprising a compound selected from the group consisting of LiPF₆, LiBF₄, LiClO₄, ethylene carbonate, dimethyl carbonate, and diethyl carbonate.

12. The electrode of claim 1, wherein the nanotubes are multi-walled carbon nanotubes or single-walled carbon nanotubes.

13. The electrode of claim 1, wherein the layer of carbon nanotubes has a thickness in the range from about 10 nm to about 1000 nm.

14. The electrode of claim 1 containing from about 2 to about 500 active material assembly layers.

15. The electrode of claim 1 which is suitable for use as a cathode or an anode.

16. The electrode of claim 1, wherein the substrate comprises a material selected from the group consisting of aluminum, copper, and silver.

17. An electrochemical half cell comprising the electrode of claim 1 and an electrolyte.

18. An electrochemical cell comprising a cathode, an anode, and at least one electrolyte, wherein the cell comprises one or more electrodes according to claim 1.

19. A rechargeable battery comprising one or more electrodes of claim 1 or one or more electrochemical cells of claim 18.

20. The battery of claim 19 capable of undergoing at least 2000 charging/discharging cycles without a loss of energy density.

21. The battery of claim 19 which is a Li ion battery.

22. The battery of claim 19 which is capable of being recharged at a rate of at least 20C.

23. A method of making an electrode for a rechargeable battery, the method comprising the steps of:
(a) depositing a layer of carbon nanotubes onto an electrically conductive substrate; and
(b) depositing a layer of electrochemically active nanoparticles onto the layer of nanotubes, wherein the layer of nanotubes together with the layer of nanoparticles forms a first active material assembly layer.

24. The method of claim 23, wherein the substrate is pretreated to remove organic surface material.

25. The method of claim 24, wherein the pretreatment comprises the use of mechanical abrasion or chemical treatment of the surface.

26. The method of claim 23, further comprising
(c) depositing one or more additional active material assembly layers onto the first active material assembly layer.

27. The method of claim 23, wherein the carbon nanotubes are deposited onto the substrate by electrophoresis, spin coating, or fluidic assembly.

28. The method of claim 23, wherein the nanoparticles are deposited onto the nanotubes by electrophoresis, spin coating, or fluidic assembly.

29. The method of claim 23, wherein a total of at least 2 active material assembly layers are deposited onto the substrate.

30. A method of making a rechargeable battery, the method comprising installing the electrode of claim 1 into a rechargeable battery as either the cathode or the anode.
